(19) United States
(12) Patent Application Publication
(10) Pub. No.: US 2020/0096077 A1
(43) Pub. Date: Mar. 26, 2020

(54) POWER TRANSMISSION DEVICE

(71) Applicant: EXEDY Corporation, Osaka (JP)

(72) Inventors: Hiroshi UEHARA, Neyagawa-shi (JP); Katsunari KATO, Neyagawa-shi (JP)

(73) Assignee: Exedy Corporation

(21) Appl. No.: 16/530,799

(22) Filed: Aug. 2, 2019

(30) Foreign Application Priority Data
Sep. 26, 2018 (JP) 2018-179875
Apr. 5, 2019 (JP) 2019-072575

(51) Int. Cl. F16F 15/134; F16F 15/123; F16F 15/30

(52) U.S. Cl. CPC F16F 15/13484; F16F 15/30; F16F 15/12366

(57) ABSTRACT

A power transmission device includes a first rotary member, a second rotary member, and a damper mechanism. The first rotary member includes a chamber in an interior thereof. The second rotary member is disposed to be rotatable relative to the first rotary member. The damper mechanism is configured to elastically couple the first rotary member and the second rotary member in a rotational direction. The damper mechanism includes a first damper part disposed inside the chamber and configured to transmit power together with the first rotary member therebetween, a second damper part disposed outside the chamber and radially inward of the first damper part and configured to transmit the power together with the second rotary member therebetween, and an intermediate member including an inertia portion disposed outside the chamber and configured to couple the first damper part and the second damper part.

### CROSS-REFERENCE TO RELATED APPLICATIONS

This application claims priority to Japanese Patent Application No. 2018-179875, filed Sep. 26, 2018 and Japanese Patent Application No. 2019-72575, filed Apr. 5, 2019. The contents of those applications are incorporated by reference herein in their entirety.

### TECHNICAL FIELD

The present invention relates to a power transmission device.

### BACKGROUND ART

A power transmission device described in Japan Laid-open Patent Application Publication No. 2007-247723 has been provided as a device for transmitting power from an engine or motor as a drive source to a transmission side. The device described in Japan Laid-open Patent Application Publication No. 2007-247723 includes a first flywheel, an intermediate rotor and a second flywheel. The intermediate rotor is disposed to be rotatable relative to the first flywheel, while the second flywheel is disposed to be rotatable relative to the intermediate rotor. Additionally, the first flywheel and the intermediate rotor are elastically coupled in a rotational direction by a first damper, while the intermediate rotor and the second flywheel are elastically coupled in the rotational direction by a second damper.

Moreover, when inputted to the first flywheel, power is transmitted through a path of the first damper, the intermediate rotor, the second damper and the second flywheel, and is then inputted to a clutch device attached to the second flywheel. Furthermore, in transmission of the power, vibration attributed to fluctuation in rotation is attenuated by the first and second dampers.

In such a power transmission device as described in Japan Laid-open Patent Application Publication No. 2007-247723, vibration attenuation performance is affected by the inertia amount of the first flywheel, that of the intermediate rotor and that of the second flywheel. For example, the vibration attenuation performance can be enhanced by making larger the inertia amount of the second flywheel disposed on an output side than that of the first flywheel disposed on an input side, albeit this depends on the specification of an engine or so forth.

Now, when such a power transmission device as described in Japan Laid-open Patent Application Publication No. 2007-247723 is installed in, for instance, a hybrid vehicle, a motor having a large inertia amount is attached to the output side of the second flywheel. Because of this, even when the inertia amount on the output side, i.e., the inertia amount of the second flywheel is made larger, this does not significantly affect the vibration attenuation performance.

In view of this, it is preferable to make larger the inertia amount of the intermediate rotor. However, it is difficult to make larger the inertia amount of the intermediate rotor in the device described in Japan Laid-open Patent Application Publication No. 2007-247723.

It is an object of the present invention to make larger the inertia amount of a member disposed amid an input-side member and an output-side member so as to enhance vibration attenuation performance.

### BRIEF SUMMARY

(1) A power transmission device according to the present invention includes a first rotary member, a second rotary member and a damper mechanism. The first rotary member includes a chamber in an interior thereof. The second rotary member is disposed to be rotatable relative to the first rotary member. The damper mechanism elastically couples the first rotary member and the second rotary member in a rotational direction.

Additionally, the damper mechanism includes a first damper part, a second damper part and an intermediate member. The first damper part is disposed inside the chamber, and transmits power together with the first rotary member therebetween. The second damper part is disposed outside the chamber and radially inward of the first damper part, and transmits the power together with the second rotary member therebetween. The intermediate member includes an inertia portion disposed outside the chamber, and couples the first damper part and the second damper part.

In the present device, for instance, the power inputted to the first rotary member is transmitted in a path of “the first damper part>the intermediate member>the second damper part>the second rotary member”. Also, vibration is attenuated by actuation of each damper part.

The inertia portion of the intermediate member is herein disposed outside the chamber. Hence, the intermediate member can be extended radially outward. Because of this, the inertia amount of the intermediate member can be made larger than that in a well-known device. Consequently, good vibration attenuation performance can be obtained even when, for instance, the present device is installed in a type of hybrid vehicle in which a motor is attached to an output side of the second rotary member.

(2) Preferably, the first rotary member includes an outer peripheral tubular portion that forms part of the chamber. Additionally, the inertia portion is disposed radially outward of the outer peripheral tubular portion.

Here, the inertia portion is disposed further radially outward of the outer peripheral tubular portion of the first rotary member. Hence, the inertia amount of the intermediate member can be made larger. Besides, increase in axial dimension of the present device can be avoided.

(3) Preferably, the intermediate member includes a first transmission member, a second transmission member and a coupling member. The first transmission member transmits the power together with the first damper part therebetween. The second transmission member transmits the power together with the second damper part therebetween. The coupling member couples the first transmission member and the second transmission member, and includes the inertia portion in an outer peripheral part thereof.

Here, the inertia amount of the intermediate member can be easily made larger by the inertia portion of the coupling member. Therefore, vibration attenuation performance can be easily enhanced.

(4) Preferably, the first damper part includes a plurality of first elastic members, and the second damper part includes a plurality of second elastic members.

Besides, preferably, the first transmission member includes a body having a disc shape and a plurality of engaging portions. The plurality of engaging portions protrude from the body radially outward, and are put into the chamber. The plurality of engaging portions transmit the power together with the plurality of first elastic members therebetween.

Moreover, preferably, the coupling member is a disc-shaped plate. The coupling member extends radially outward along a first axial side lateral surface of the first rotary member, and is coupled at an inner peripheral end thereof to the body of the first transmission member.

Furthermore, preferably, the second transmission member includes a first holding member and a second holding member. The first holding member extends along a lateral surface of the coupling member on a first axial side of the second rotary member, and is fixed to the inertia portion. The first holding member includes a first holding portion holding each of the plurality of second elastic members. The second holding member is disposed in opposition to the first holding member on a second axial side of the second rotary member, and is fixed to the first holding member. The second holding member includes a second holding portion holding each of the plurality of second elastic members together with the first holding portion.

In this case, for instance, power transmitted to the first elastic members is transmitted to the first transmission member, and is further sequentially transmitted to the coupling member, the first and second holding members, the second elastic members, and the second rotary member in this order.

The coupling member herein extends along the lateral surface of the first rotary member. Hence, the inertia amount of the intermediate member can be made larger, while increase in axial dimension of the entire device can be inhibited. Moreover, the first holding member extends along the lateral surface of the coupling member on the first axial side of the second rotary member, whereas the second holding member is disposed in opposition to the first holding member on the second axial side of the second rotary member. Hence, increase in axial dimension of the entire device can be inhibited.

(5) Preferably, the plurality of second elastic members are disposed radially inward of the first transmission member while being axially displaced from the plurality of first elastic members. The plurality of second elastic members axially overlap in part the first transmission member.

Here, the second elastic members are disposed to be axially displaced from the first elastic members. However, the second elastic members are disposed to axially overlap in part the first transmission member. Therefore, increase in axial dimension of the device can be inhibited.

(6) Preferably, the power transmission device further includes a seal part sealing an internal space of the chamber.

In this case, a viscous fluid such as grease can be encapsulated into the chamber, whereby it is possible to obtain a vibration attenuation effect exerted by the viscous fluid.

(7) Preferably, the chamber contains a viscous fluid in an interior thereof. In other words, the first damper part, disposed inside the chamber, is provided as a wet-type damper.

In such a we-type damper, lubrication can be made by the viscous fluid, whereby abrasion of members can be inhibited.

On the other hand, in attempt to realize multistage characteristics, widening in torsion angle, and so forth, such a wet-type damper requires a configuration that springs are disposed on the inner peripheral side and the outer peripheral side. However, in order to dispose all the inner and outer peripheral side springs inside the chamber in the wet-type damper, increase in volume of the chamber is inevitable whereby a large amount of viscous fluid is required.

In view of this, the first damper part is herein provided as a wet-type damper disposed inside the chamber containing the viscous fluid in the interior thereof, whereas the second damper part is provided as a thy-type damper disposed outside the chamber.

(8) Preferably, the first rotary member receives the power inputted thereto from an engine, and the second rotary member is connected at an output side thereof to a motor. Besides, in this case, the intermediate member has an inertia amount greater than or equal to 0.2 times as much as an inertia amount of the motor and less than or equal to 3.0 times as much as the inertia amount of the motor.

Here, good vibration attenuation performance can be obtained in a hybrid vehicle by increasing the inertia mount of the intermediate member. Additionally, increase in size of the device can be avoided.

Overall, in the present invention described above, a member disposed amid an input-side member and an output-side member can be made larger in inertia amount, whereby vibration attenuation performance can be enhanced.

### BRIEF DESCRIPTION OF THE DRAWINGS

FIG. 1 is a cross-sectional configuration view of a power transmission device according to a preferred embodiment of the present invention.

FIG. 2 is a front view of the device shown in FIG. 1.

FIG. 3 is an exploded perspective view of the device shown in FIG. 1.

FIG. 4 is a partial enlarged view of FIG. 1.

FIG. 5 is a partial cross-sectional view of a power transmission device according to another preferred embodiment of the present invention.

FIG. 6 is a schematic diagram of a power transmission path in a hybrid vehicle in which the power transmission device according to the preferred embodiment of the present invention is installed.

### DETAILED DESCRIPTION

[Entire Configuration]

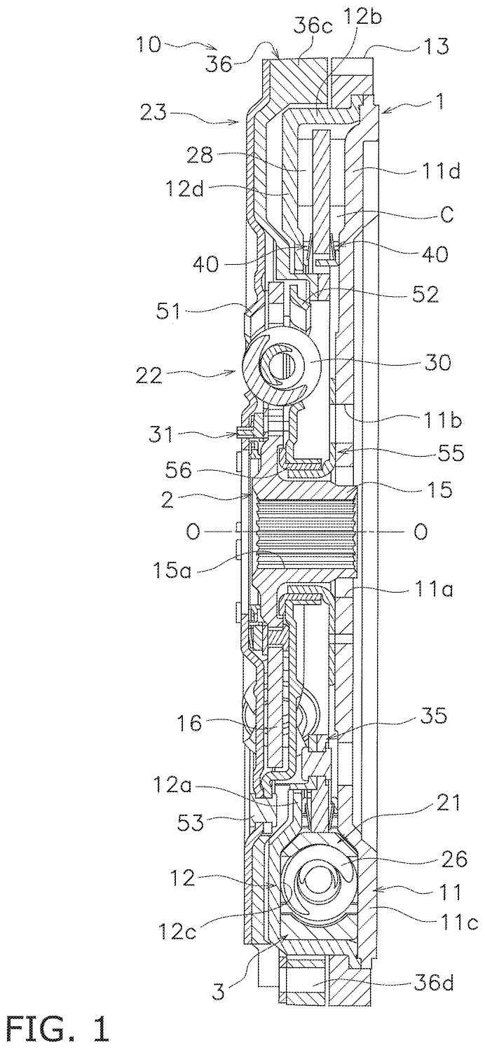

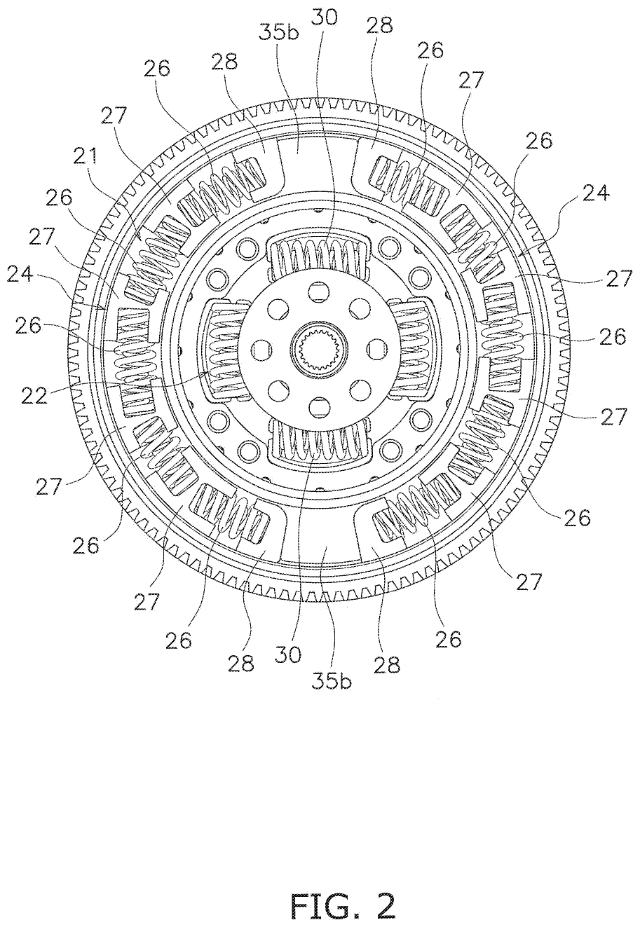

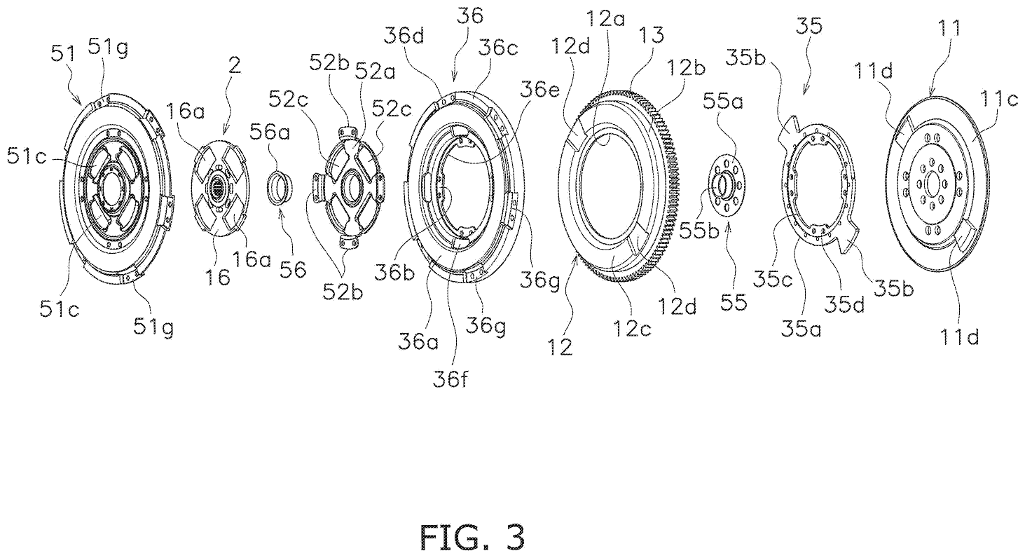

FIG. 1 shows a cross section of a power transmission device 10 according to a preferred embodiment of the present invention. Additionally, FIG. 2 is a front view of the power transmission device 10, from which some of members shown in FIG. 1 are detached. Moreover, FIG. 3 is an exploded view of the power transmission device 10. FIG. 3 omits illustration of part of the configuration of the power transmission device 10.

In FIG. 1, a drive source (e.g., engine) is disposed on the right side of the power transmission device 10, whereas such a mechanism as a transmission is disposed on the left side of the power transmission device 10. The term “transmission side” (first axial side) hereinafter refers to the left side in FIG. 1, whereas the term “engine side” (second axial side) hereinafter refers to the right side in FIG. 1. Additionally, when the present device is installed in a hybrid vehicle, a motor is disposed on the left side (i.e., output side). It should be noted that in FIG. 1, line O-O indicates a rotational center line.

The power transmission device 10 includes a first rotary member 1 disposed on an input side, a second rotary member 2 disposed on the output side, and a damper mechanism 3 disposed between the first rotary member 1 and the second rotary member 2 in a power transmission path.

[First Rotary Member 1]

The first rotary member 1, to which power is inputted from the drive source, includes a first plate 11 and a second plate 12.

The first plate 11 is made in the shape of a disc having an opening 11a in the center part thereof. The first plate 11 is provided with a plurality of holes 11b in the inner peripheral part thereof, and is fixed to an engine-side member by bolts (not shown in the drawings) attached to the holes 11b. The first plate 11 is provided with two accommodation portions 11c in the outer peripheral part thereof. The accommodation portions 11c extend toward the engine. Additionally, two engaging portions 11d are provided between the accommodation portions 11c.

The second plate 12 includes an annular portion 12a and an outer peripheral tubular portion 12b. The annular portion 12a is disposed in axial opposition to the outer peripheral part of the first plate 11, and includes two accommodation portions 12c and two engaging portions 12d. The accommodation portions 12c are disposed in opposition to the accommodation portions 11c of the first plate 11, and are shaped to protrude toward the transmission. On the other hand, the engaging portions 12d are disposed in opposition to the engaging portions 11d of the first plate 11. The outer peripheral tubular portion 12b is shaped to extend from the outer peripheral end of the annular portion 12a toward the engine. Besides, the outer peripheral tubular portion 12b is fixed at the distal end thereof to the outer peripheral end of the first plate 11 by welding. It should be noted that a ring gear 13 is fixed to the outer peripheral surface of the outer peripheral tubular portion 12b.

With the configuration described above, a chamber C is formed in the interior of the first rotary member 1, while being enclosed by the outer peripheral part of the first plate 11 and the second plate 12 (the annular portion 12a and the outer peripheral tubular portion 12b). A viscous fluid such as grease is encapsulated in the interior of the chamber C.

[Second Rotary Member 2]

The second rotary member 2 is rotatable relative to the first rotary member 1. The second rotary member 2 is disposed in approximately the same position as the first rotary member 1 in the axial direction. In other words, the second rotary member 2 is disposed to radially overlap the first rotary member 1. The second rotary member 2 includes a hub 15 and a flange 16.

The hub 15 has a tubular shape and the distal end thereof extends to the opening 11 a provided in the center part of the first plate 11. The hub 15 is provided with a spline hole 15a on the inner peripheral surface thereof, and a transmission-side member (not shown in the drawings) is engaged with the spline hole 15a.

The flange 16 is made in the shape of a disc extending radially outward from the outer peripheral surface of the hub 15. As shown in FIGS. 2 and 3, the flange 16 is provided with four accommodation portions 16a. The respective accommodation portions 16a are openings axially penetrating the flange 16.

[Damper Mechanism 3]

The damper mechanism 3 elastically couples the first rotary member 1 and the second rotary member 2 in a rotational direction. The damper mechanism 3 includes a first damper part 21, a second damper part 22 and an intermediate member 23.

<First Damper Part 21>

The first damper part 21 is disposed in the interior of the chamber C of the first rotary member 1, and transmits power together with the first rotary member 1 therebetween. In other words, the first damper part 21 is a wet-type damper. As shown in FIG. 2, the first damper part 21 includes two elastic units 24. Each elastic unit 24 includes five outer peripheral side springs 26 (exemplary first elastic member), four intermediate seats 27 and two end seats 28.

The five outer peripheral side springs 26 are disposed in circumferential alignment. Each of the four intermediate seats 27 is disposed circumferentially between adjacent two of the outer peripheral side springs 26. The two end seats 28 are disposed on the circumferential ends of each elastic unit 24. Additionally, the two end seats 28 make contact with the engaging portions 11d and 12d of the first and second plates 11 and 12, respectively. Therefore, power is transmitted from the first rotary member 1 to each elastic unit 24 through the engaging portions 11d and 12d.

<Second Damper Part 22>

The second damper part 22 is a dry-type damper disposed outside the chamber C. As shown in FIGS. 1 and 2, the second damper part 22 includes four inner peripheral side springs 30 (exemplary second elastic member) and a hysteresis torque generating mechanism 31. The four inner peripheral side springs 30 are disposed in circumferential alignment, and are actuated in parallel. The inner peripheral side springs 30 are accommodated in the accommodation portions 16a provided in the flange 16, respectively, while being for instance compressed therein. The hysteresis torque generating mechanism 31 has a similar structure to a well-known hysteresis torque generating mechanism, and includes a friction member, a cone spring provided as an urging member, and so forth. Detailed explanation of the hysteresis torque generating mechanism 31 will be hereinafter omitted.

<Intermediate Member 23>

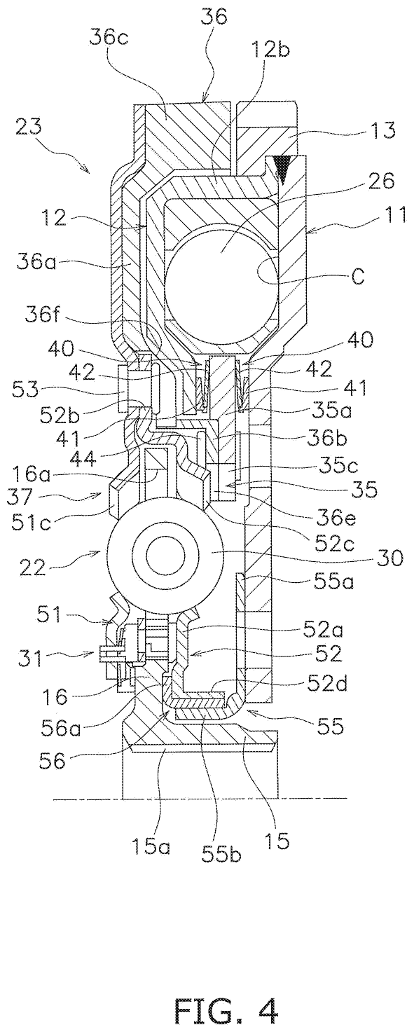

The intermediate member 23 is a member for coupling the first damper part 21 and the second damper part 22. As shown in FIGS. 3 and 4, the intermediate member 23 includes a first transmission member 35, a coupling member 36 and a second transmission member 37. It should be noted that FIG. 4 is an enlarged view of part of FIG. 1.

First Transmission Member 35

The first transmission member 35 transmits power together with the first damper part 21 therebetween. As shown in FIG. 3, the first transmission member 35 includes a body 35a having an annular shape and two engaging portions 35b. The body 35a is made thinner in an inner peripheral end 35c than in the other part thereof. The inner peripheral end 35c is provided with a plurality of holes 35d for coupling use. On the other hand, the two engaging portions 35b protrude from the body 35a radially outward and are put into the chamber C. Additionally, the two engaging portions 35b are engaged with the end seats 28. Accordingly, power, inputted to the elastic units 24, is transmitted to the first transmission member 35 through the end seats 28 and the engaging portions 35b.

As shown in FIG. 1, seal parts 40 are provided axially on the both sides of the body 35a of the first transmission member 35. In more detail, as shown close-up in FIG. 4, two pairs of a friction member 41 and a cone spring 42 are provided between the first plate 11 and the body 35a and between the second plate 12 and the body 35a, respectively. Each friction member 41 is being pressed onto the lateral surface of the relevant plate 11, 12 thereof by each cone spring 42. Accordingly, the viscous fluid encapsulated in the chamber C is prevented from leaking to the outside.

Coupling Member 36

The coupling member 36 is disposed on the transmission side of the first rotary member 1, and couples the first transmission member 35 and the second transmission member 37. The coupling member 36 includes a disc portion 36a, a fixation portion 36b and an inertia portion 36c.

The disc portion 36a extends radially outward along the lateral surface of the second plate 12 composing part of the first rotary member 1. The fixation portion 36b is provided on the inner peripheral end of the disc portion 36a, and is offset (or displaced) from the disc portion 36a to the engine side. Additionally, the fixation portion 36b is fixed to the inner peripheral end 35c (i.e., the thin portion) of the first transmission member 35 by rivets 44. The inertia portion 36c is provided on the outer peripheral end of the disc portion 36a so as to protrude toward the engine. The inertia portion 36c has an annular shape, and is axially thicker than the disc portion 36a. Additionally, the inertia portion 36c is disposed to cover the outer peripheral surface (except for a part to which the ring gear 13 is attached) of the outer peripheral tubular portion 12b of the second plate 12. It should be noted that the inertia portion 36c is provided with a plurality of screw holes 36d for fixation use.

Second Transmission Member 37

The second transmission member 37 transmits power together with the second damper part 22 therebetween. The second transmission member 37 includes a first holding plate 51 (first holding member) and a second holding plate 52 (second holding member).

The first holding plate 51 is disposed on the transmission side of the second rotary member 2, and is also disposed on the transmission side of the coupling member 36. A region of the first holding plate 51, ranging from a radially intermediate part thereof to an outer peripheral part thereof, extends along the lateral surface of the coupling member 36. Additionally, the outer peripheral end of the first holding plate 51 is fixed to the inertia portion 36c of the coupling member 36 by bolts (not shown in the drawings). The first holding plate 51 is provided with four first holding portions 51c in the inner peripheral part thereof. The first holding portions 51c are disposed in opposition to the accommodation portions 16a of the second rotary member 2. Each first holding portion 51c holds each inner peripheral side spring 30 accommodated in each accommodation portion 16a of the second rotary member 2.

The second holding plate 52 is disposed on the engine side of the second rotary member 2 so as to be axially opposed to the first holding plate 51. The second holding plate 52 includes a disc portion 52a and four coupling portions 52b. The disc portion 52a is provided with four second holding portions 52c. Each second holding portion 52c is disposed in opposition to each accommodation portion 16a and each first holding portion 51c. Additionally, each second holding portion 52c holds each inner peripheral side spring 30 together with each first holding portion 51c, whereby each inner peripheral side spring 30 is restricted from moving in the radial direction and the axial direction. The coupling portions 52b are shaped to protrude from the disc portion 52a to the outer peripheral side, and are fixed to the first holding plate 51 by rivets 53.

[Structure for Supporting Intermediate Member 23]

As shown in FIGS. 1, 3 and 4, a support member 55 is attached to the inner peripheral end of the first rotary member 1. The support member 55 is an annular member and includes a fixation portion 55a and an inner peripheral side support portion 55b.

The fixation portion 55a is fixed to the inner peripheral end of the first rotary member 1 by bolts. The inner peripheral side support portion 55b is made in the shape of a tube extending toward the transmission from the inner peripheral end of the fixation portion 55a.

On the other hand, the second holding plate 52 is provided with an outer peripheral side support portion 52d on the inner peripheral end thereof. The outer peripheral side support portion 52d is formed by extending the inner peripheral end of the second holding plate 52 toward the engine. The outer peripheral side support portion 52d is radially opposed to the inner peripheral side support portion 55b of the support member 55.

Additionally, a bushing 56 is provided, as a bearing, between the outer peripheral side support portion 52d and the inner peripheral side support portion 55b. Accordingly, the outer peripheral side support portion 52d is rotatably supported by the inner peripheral side support portion 55b through the bushing 56. In other words, the intermediate member 23, including the second holding plate 52, is rotatably supported by the first rotary member 1 to which the support member 55 is fixed, while being radially positioned with respect thereto. Because of this, during device actuation, the intermediate member 23 can be made constantly stable in posture.

It should be noted that the transmission-side end of the bushing 56 is bent radially outward, and this bent portion 56a is interposed axially between the flange 16 of the second rotary member 2 and the second holding plate 52. Because of this, the bushing 56 is restricted from moving in the axial direction.

[Configurations for Reducing Axial Dimension]

Reduction in axial dimension of the present device is realized with the following configurations.

(1) The coupling member 36 is disposed along the lateral surface of the second plate 12, while the first holding plate 51 is disposed along the lateral surface of the coupling member 36.

(2) The inner peripheral end 35c of the first transmission member 35 is made thin, and the fixation portion 36b of the coupling member 36 is fixed to the thin part 35c.

(3) The inner peripheral side springs 30 are disposed radially inward of the first transmission member 35, while being axially displaced from the outer peripheral side springs 26. Additionally, the inner peripheral side springs 30 are disposed to axially overlap the first transmission member 35.

In the configuration described above, the coupling member 36 is provided with a plurality of cutouts 36e (see FIGS. 3 and 4) on the inner peripheral end thereof, and the second holding portions 52c of the second holding plate 52 are put into the cutouts 36e. In other words, the second holding plate 52 is configured not to interfere with the fixation portion 36b of the coupling member 36 fixed to the first transmission member 35 even when located closely to the first transmission member 35. Accordingly, the intermediate member 23 is entirely made as small as possible in axial dimension.

(4) The coupling member 36 is provided with openings 36f in a radially intermediate part thereof, and the coupling portions 52b of the second holding plate 52 and the rivets 53 are put into the openings 36f, respectively. In other words, the second holding plate 52 is configured not to interfere with the coupling member 36 even when located closely to the coupling member 36. Accordingly, the intermediate member 23 is entirely made as small as possible in axial dimension.

(5) As shown in FIG. 3, the coupling member 36 is provided with a plurality of recesses 36g on the inertia portion 36c. The recesses 36g are shaped by recessing the surface (transmission-side end surface) of the inertia portion 36c toward the engine. On the other hand, the first holding plate 51 includes portions 51g on the outer peripheral end thereof, and the portions 51g are offset (or displaced) toward the engine so as to be fitted to the recesses 36g, respectively. Thus, the offset portions 51g of the first holding plate 51 are fixed to the recesses 36g of the inertia portion 36c by bolts, respectively. Therefore, the heads of the bolts do not protrude therefrom toward the transmission, and the entire device is made as small as possible in axial dimension.

[Action]

When power is inputted to the first rotary member 1, the inputted power is transmitted from the engaging portions 11d and 12d of the first and second plates 11 and 12 to the outer peripheral side springs 26 through the end seats 28. The engaging portions 35b of the first transmission member 35 are also engaged with the ends of the outer peripheral side springs 26. Hence, the power transmitted to the outer peripheral side springs 26 is transmitted to the first transmission member 35, and is further transmitted to the first and second holding plates 51 and 52 of the second transmission member 37 through the coupling member 36.

Each inner peripheral side spring 30 is engaged with each first holding portion 51c of the first holding plate 51 and each second holding portion 52c of the second holding plate 52, while the ends of each inner peripheral side spring 30 make contact with the end surfaces of each accommodation portion 16a of the second rotary member 2. Therefore, the power, transmitted from the first and second holding plates 51 and 52 to the inner peripheral side springs 30, is transmitted to the second rotary member 2. Then, the power is outputted to the transmission-side member engaged with the spline hole 15a of the hub 15 of the second rotary member 2.

In transmission of power described above, the outer peripheral side springs 26 and the inner peripheral side springs 30 are compressed and expanded. At this time, relative rotation occurs between the first and second plates 11 and 12 (i.e., the inner peripheral surface of the chamber) and both the intermediate seats 27 and the end seats 28. Relative rotation occurs as well between the second rotary member 2 and the first and second holding plates 51 and 52. Therefore, friction resistance (i.e., hysteresis torque) is generated between these members. Moreover, a hysteresis torque is also generated by circulation of the viscous fluid in the interior of the chamber C.

With the actuation described above, vibration attributed to fluctuation in rotation can be attenuated. Especially in the configuration of the present preferred embodiment, the intermediate member 23 including the coupling member 36 can be reliably produced with a large inertia amount, whereby vibration attenuation performance can be herein more enhanced than in a well-known device. Additionally, when the present device is applied to a type of hybrid vehicle in which a motor is installed on the output side of the second rotary member 2, vibration attenuation performance can be further enhanced.

Moreover, the intermediate member 23 is rotatably supported by the first rotary member 1, to which the support member 55 is fixed, through the bushing 56, while being radially positioned with respect to the first rotary member 1. Because of this, during device actuation, the intermediate member 23 can be made constantly stable in posture.

Furthermore, the first damper part 21 is disposed in the chamber C containing the viscous fluid in the interior thereof. Hence, the members composing the first damper part 21 can be sufficiently lubricated, and can be inhibited from being abraded.

On the other hand, the second damper part 22 is disposed outside the chamber C. Hence, widening of torsion angle in torsional characteristics can be realized without enlarging the chamber C.

[Application to Hybrid Vehicle]

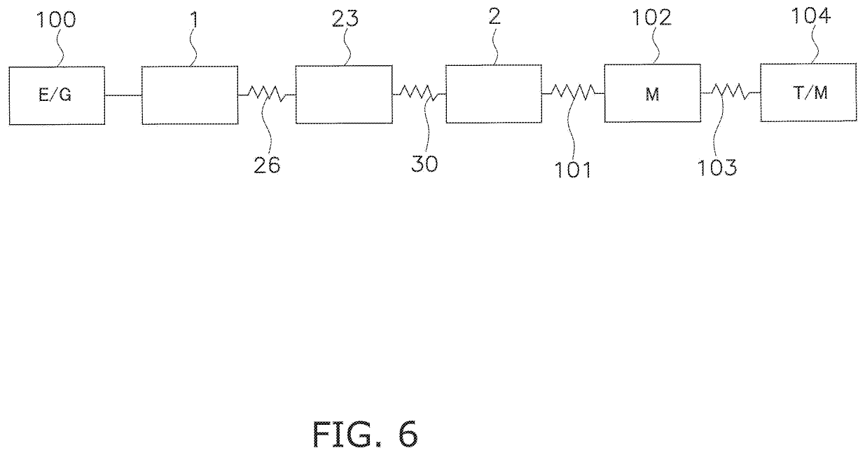

FIG. 6 is a schematic diagram of a power transmission path in applying the power transmission device according to the preferred embodiment of the present invention to a hybrid vehicle.

As shown in the drawing, power is inputted to the first rotary member 1 from an engine 100. The power, inputted to the first rotary member 1, is then transmitted to the second rotary member 2 through the outer peripheral side springs 26, the intermediate member 23 and the inner peripheral side springs 30. A motor 102 is connected to the second rotary member 2 through a shaft 101 spline-coupled to the second rotary member 2. Furthermore, a transmission 104 is connected to the motor 102 through a shaft 103.

In the power transmission path described above, the inertia amount of the intermediate member 23 is preferably greater than or equal to 0.2 times as much as the inertia amount of the motor 102 and less than or equal to 3.0 times as much as the inertia amount of the motor 102. When the inertia amount of the intermediate member 23 is greater than or equal to 0.2 times as much as the inertia amount of the motor 102, the peak of vibration shifts to a range of engine rotation lower than a normal range of engine rotation. Because of this, while the engine is used in the normal range of engine rotation, the peak of vibration does not appear. Besides in the normal range of engine rotation, vibration is inhibited. Hence, vibration attenuation effect can be enhanced. However, chances are that the aforementioned effect cannot be expected when the inertia mount of the intermediate member 23 is less than 0.2 times as much as the inertia amount of the motor 102. Contrarily, when the inertia amount of the intermediate member 23 is greater than 3.0 times as much as the inertia amount of the motor 102, this configuration is not preferable because the intermediate member 23 is shaped too large whereby too much increase in size of the device is inevitable.

[Other Preferred Embodiments]

The present invention is not limited to the preferred embodiment described above, and a variety of changes or modifications can be made without departing from the scope of the present invention.

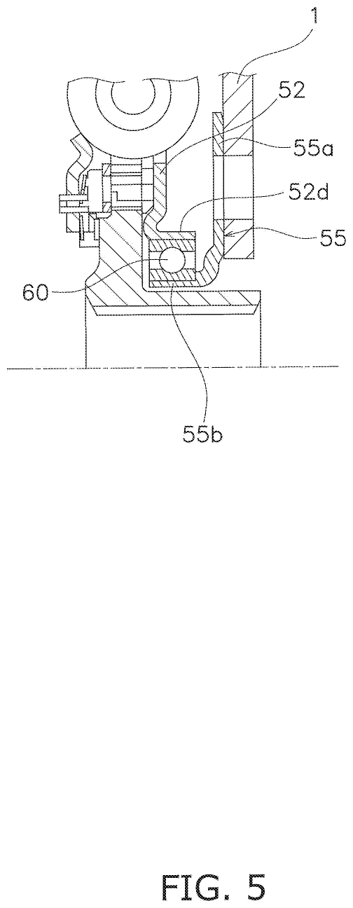

(a) In the aforementioned preferred embodiment, the bushing 56 is employed as a bearing through which the intermediate member 23 is supported by the first rotary member 1. However, as shown in FIG. 5, a ball bearing 60 can be employed.

In this preferred embodiment, the support member 55 is, similarly to that in the aforementioned preferred embodiment, fixed to the inner peripheral end of the first rotary member 1, and includes the fixation portion 55a and the inner peripheral side support portion 55b. Additionally, the second holding plate 52 is provided with the outer peripheral side support portion 52d on the inner peripheral end thereof. Moreover, the ball bearing 60 is provided between the outer peripheral side support portion 52d of the second holding plate 52 and the inner peripheral side support portion 55b of the support member 55.

With this configuration, the intermediate member 23, including the second holding plate 52, is rotatably supported by the first rotary member 1 to which the support member 55 is fixed, while being radially positioned with respect thereto.

(b) The number and layout of the springs composing part of each damper part are not limited to those in the aforementioned preferred embodiment. A variety of changes can be made with respect thereto.

### REFERENCE SIGNS LIST

1 First rotary member

2 Second rotary member

3 Damper mechanism

21 First damper part

22 Second damper part

23 Intermediate member

26 Outer peripheral side spring

30 Inner peripheral side spring

35 First transmission member

35a Body

35b Engaging portion

36 Coupling member

36c Inertia portion

37 Second transmission member

40 Seal part

51 First holding plate

51c First holding portion

52 Second holding plate

52c Second holding portion

C Chamber

What is claimed is:

1. A power transmission device comprising:
a first rotary member including a chamber in an interior thereof;
a second rotary member disposed to be rotatable relative to the first rotary member; and
a damper mechanism configured to elastically couple the first rotary member and the second rotary member in a rotational direction, wherein
the damper mechanism includes
a first damper part disposed inside the chamber, the first damper part configured to transmit power together with the first rotary member therebetween,
a second damper part disposed outside the chamber and radially inward of the first damper part, the second damper part configured to transmit the power together with the second rotary member therebetween, and
an intermediate member including an inertia portion disposed outside the chamber, the intermediate member configured to couple the first damper part and the second damper part.

2. The power transmission device according to claim 1, wherein
the first rotary member includes an outer peripheral tubular portion, the outer peripheral tubular portion forming part of the chamber, and
the inertia portion is disposed radially outward of the outer peripheral tubular portion.

3. The power transmission device according to claim 1, wherein the intermediate member includes
a first transmission member configured to transmit the power together with the first damper part therebetween,
a second transmission member configured to transmit the power together with the second damper part therebetween, and
a coupling member configured to couple the first transmission member and the second transmission member, the coupling member including the inertia portion in an outer peripheral part thereof.

4. The power transmission device according to claim 3, wherein
the first damper part includes a plurality of first elastic members,
the second damper part includes a plurality of second elastic members,
the first transmission member includes
a body having a disc shape, and
a plurality of engaging portions protruding from the body radially outward, the plurality of engaging portions put into the chamber, the plurality of engaging portions configured to transmit the power together with the plurality of first elastic members therebetween,
the coupling member is a disc-shaped plate, the coupling member extending radially outward along a first axial side lateral surface of the first rotary member, the coupling member coupled at an inner peripheral end thereof to the body of the first transmission member, and
the second transmission member includes
a first holding member extending along a lateral surface of the coupling member on a first axial side of the second rotary member, the first holding member fixed to the inertia portion, the first holding member including a first holding portion, the first holding portion holding each of the plurality of second elastic members, and
a second holding member disposed in opposition to the first holding member on a second axial side of the second rotary member, the second holding member fixed to the first holding member, the second holding member including a second holding portion, the second holding portion holding each of the plurality of second elastic members together with the first holding portion.

5. The power transmission device according to claim 4, wherein the plurality of second elastic members are disposed radially inward of the first transmission member while being axially displaced from the plurality of first elastic members, the plurality of second elastic members axially overlapping in part the first transmission member.

6. The power transmission device according to claim 1, further comprising:
a seal part sealing an internal space of the chamber.

7. The power transmission device according to claim 6, wherein the chamber contains a viscous fluid in an interior thereof.

8. The power transmission device according to claim 1, wherein
the first rotary member receives the power inputted thereto from an engine,
the second rotary member is connected at an output side thereof to a motor, and
the intermediate member has an inertia amount greater than or equal to 0.2 times as much as an inertia amount of the motor and less than or equal to 3.0 times as much as the inertia amount of the motor.
